(19) United States
(12) Patent Application Publication
(10) Pub. No.: US 2020/0184817 A1
(43) Pub. Date: Jun. 11, 2020

(54) Automated Parking system and scanning event for mobile devices

(71) Applicant: FNU RASHI, JERSEY CITY, NJ (US)

(72) Inventor: FNU RASHI, JERSEY CITY, NJ (US)

(21) Appl. No.: 16/212,669

(22) Filed: Dec. 6, 2018

(51) Int. Cl. G08G 1/14; G06Q 30/02; H04W 4/021

(52) U.S. Cl. CPC G08G 1/143; G06Q 2240/00; H04W 4/021; G06Q 30/0284

(57) ABSTRACT

The invention provides a parking device for automated parking by opening a gate automatically using a mobile device. The system comprises of at least one device to scan/sense the identity, date and time of the entry of the user; and an application server to receive this input to confirm the identity of the user and to identify and grant automatic access to the user. The system also comprise one device to scan/sense the identity, date and time of the exit of the user; and application server to receive this input to confirm the identity of the user, grant him automatic exit to the parking lot and calculate payment using time and date of entry and exit. User's cellphone acts as an alternate method of entry/exit and payment instead of cash or credit card. The invention provides a method for parking automations, the method comprising automatic entry of the user, automatic exit of the user by similar scan/sensor the identity of the user using a mobile device; detecting date and time of the parking and calculating the payment required by the duration of the car parked. This invention also provides enforcement agency as the operators can check in the system the list of users parked in the parking real-time.

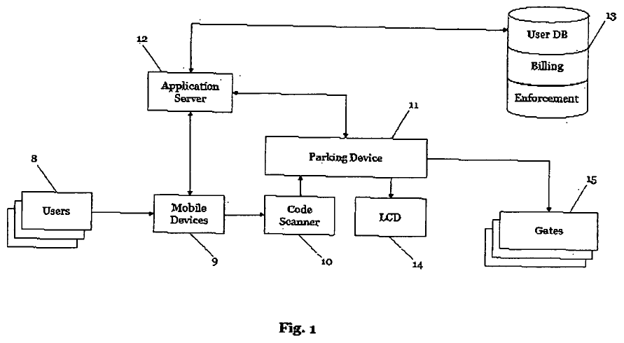

### FIELD OF INVENTION

The present invention relates of field of parking management. Specifically, it relates to automating parking management and scanning events using mobile devices

### BACKGROUND OF THE INVENTION

In most parking lots, entry and exit has become a major challenge especially in cases where an attendant is required at all time to man the parking lot. Huge dependency is on the attendant to complete payments, solve any ticketing issues, if any. In some cases, lot of user's time is spent waiting in queue so that the attendant can take payments to exit out of parking lot. Operational cost is huge in these cases

In other scenarios, a driver has to get out of the car in extreme weather conditions just to pay for the parking. These scenarios make the drivers very inconvenient for the parking

In some cases, parking lots are in closed spaces and have an attendant available most of the time for payment for parking. However, these attendants are usually provided in gated parking lots operated by huge parking operators and in any case do not provide full flexibility to the drivers to be able to park and exit automatically without any challenges

In other scenarios, parking entry and exit are automated but the challenge is that users are charged at a later point decreasing the efficiency of the overall parking management systems. This method is expensive for the parking operators and inconvenient for the users. In most cases, driver is unaware of the total payment that has to be done at the exit leaving drivers unplanned of the costs involved

Therefore, the current parking machines may not help driver in a seamless and completely automated parking as it cannot provide information on total cost of parking for x number of hours and cannot provide complete automation in terms of entry and exit of the parking lot

### SUMMARY OF THE INVENTION

in implementation, a computer-implemented method is disclosed to automate entry and exit of parking lot and accessibility via mobile phone. The invention provides a parking device for automated parking by opening a gate automatically. The system comprises of at least one device to scan/sense the identity, date and time of the entry of the user; and an application server to receive this input to confirm the identity of the user and to identify and grant automatic access to the user

In implementation, user can log in to the mobile device. End user can log in and log out in the mobile device using secure username and password

In implementation, the logged in user in mobile device, gets the system generated unique encrypted code by communicating with the application server. Code generated is to be scanned for entry in to the parking lot

In implementation, the user can scan the encrypted code generated on mobile device using the code scanner in the parking device

In implementation, the parking device receives encrypted code and connects to the application server to decode and authenticate the user

In implementation, the application server connects with the database to decrypt the code

In implementation, the database server store user information like time of entry, location and initiates billing for parked duration

In implementation, the LCD gets the input signal and displays entry allowed or denied for the user

In implementation, if signal received is yes, the parking gate opens successfully. If entry is denied, the parking gate remains closed

In implementations, the method can further include getting real-time location of the user, the date and parking time; and on entry to the parking lot creating the session for the user in the computer program to be able to calculate total parking fee at the end of the session

In implementation, confirming the identity of the user can be by decrypting the code provided by the user and comparing the code stored in the computer program created when the user registered using his mobile device

In implementation, user has a unique encrypted code

In implementation, using this unique encrypted code user can create a reservation in the parking lot which creates a record in the parking management system

In implementation, instructions are provided in the mobile device to the user to go to the parking location and scan the encrypted code to enter the parking location

In implementation, at the entry of parking lot, if encrypted code provided by user matches with the decrypted code in computer based program, user is granted access by opening the barrier gate automatically at the entry of the parking lot

In implementation, entry instructions are displayed on the lcd screen of the entry parking device

In implementation, during the exit the user scans the encrypted code at the parking exit device and compute program decrypts the code provided by the user. Computer program ends the session for the user

1. A system for parking automatic parking, the system comprising:
a. At least one device to scan/sense the entry of the user, date and time;
b. At least one device to scan/sense the exit of the user, date and time; and
c. An application server to receive the input from entry and exit device to confirm the identity of the user and calculate total price based on pricing algorithm
d. A system, wherein said parking entry device is configured to take encrypted input code, date and time of entry from user's mobile device
e. A system, wherein said parking entry device is configured to take geolocation of the user
f. A system, wherein said application server is configured to decrypt the code provided by the user at entry to validate the user

2. A system, wherein said application server is configured to provide output to the parking device with corresponding accept or deny scenario
a. A system, wherein said application server is configured to connect to the parking gate to open in case of accepted scenario; and display unauthorized entry on device if denied
b. A system according to claim 1, wherein said entry device is configured to show instructions for entry accepted/denied to the user on the screen
c. A system according to claim 1, wherein said parking exit device is configured to take encrypted input code, date and time of exit from user's mobile device
d. A system according to claim 1, wherein said application server is configured to decrypt the code provided by the user at exit to validate the user
e. A system, wherein said application server is configured to calculate total payment for the user taking into account pricing from the parking management system, entry date, entry time, exit date and exit time to provide output to the parking device and mobile device with tot

3. A system, wherein said application server is configured to provide total payment information to the mobile device of the user
a. A system according to claim 1, wherein the exit device is configured to provide exit instructions to the user and automatically opens the exit barrier for the user
b. A computer implemented method for: reserving parking and payments, the method comprising:
c. Detection of the users location in a parking spot by use of users mobile device to be able to sense the temporary location of the user; date and time of entry in the parking lot
d. A computer implemented method for determine that the user is registered with the parking management system; and is granted/denied access entry based on this registration
e. A computer implemented method for determine the users currently parked in the parking lot and future reservations in the parking lot
f. A computer implemented method for where each user has its own encrypted code in user's mobile device
g. A computer implemented method for where total parking fee is calculated based on entry and exit date and time of the user
